(19) United States
(12) Patent Application Publication
(10) Pub. No.: US 2017/0137265 A1
(43) Pub. Date: May 18, 2017

(54) Portable Apparatus For Lifting Objects

(71) Applicant: Keith Menville, Baton Rouge, LA (US)

(72) Inventor: Keith Menville, Baton Rouge, LA (US)

(21) Appl. No.: 14/940,305

(22) Filed: Nov. 13, 2015

(51) Int. Cl. B66C 23/48

(52) U.S. Cl. CPC B66C 23/48; B66C 2700/0357

(57) ABSTRACT

In general, this invention allows one to easily move a heavy object, via a lightweight portable lift. It can lift heavy electric wheelchairs, scooters to and from a vehicle. In addition, it can lift other heavy objects such as coolers, groceries, a toolbox, or lawn equipment. It is composed of a lightweight material and allows easy transportation and storage. It includes a foldable base, a hoisting arm and a power supply and motor.

### CROSS-REFERENCE TO RELATED APPLICATIONS

Not applicable.

### STATEMENT REGARDING FEDERALLY SPONSORED RESEARCH AND DEVELOPMENT

Not applicable.

### REFERENCE TO SEQUENCE LISTING APPENDIX

Not applicable.

### BACKGROUND OF INVENTION

Field of the Invention/Technical Field

The disclosure herein relates to the specific area of hoisting apparatuses, and more specifically, the technical field of portable lifting devices, and lastly, the technical area of wheelchair and scooter utilities.

Related Art of the Invention

In general, people have previously attempted to have a compact means to lift objects with an apparatus. The U.S. patent publication 2009/0152227 (2009/0152227) discloses a method and apparatus to lift payloads onto or into a vehicle. However, it does not disclose a lightweight foldable construction nor, does 2009/0152227 disclose a portable stabilizing base. The U.S. patent publication U.S. Pat. No. 5,388,289 (U.S. Pat. No. 5,388,289) discloses a knockdown, portable combination wheelchair and lift which is readily assembled and disassembled, thereby enabling stowage and transport when not in use. However, it does not disclose a separate entity, that is a portable lifting apparatus apart from the wheelchair itself. Nor, does it disclose a sturdy means for attaching a liftable object to the lifting apparatus. Nor, does it disclose an ability to have multiple objects, not only wheelchairs, be lifted by the device. The U.S. patent publication U.S. Pat. No. 6,007,289 (U.S. Pat. No. 6,007,289) discloses a lift mounted to the rear portion of a vehicle to selectively store and remove a personal mobility vehicle in and from the trunk of the vehicle. However, it does not disclose a portable base, allowing lifting of a portable mobility vehicle without being attached to a vehicle nor, does U.S. Pat. No. 6,007,289 disclose a motor not present on hoist, but on the portable mobility vehicle itself.

### GENERAL SUMMARY OF THE INVENTION

In general, the invention solves numerous problems as highlighted in the background. For example, it allows one to easily move a modified heavy electric wheelchair to and from a vehicle. Ideally it is composed of a lightweight material and will allow one the ability to use any vehicle in order to transport their electric chair. This is accomplished by a unique arrangement of specific elements, including a foldable base, a hoisting arm and a power supply and motor present on the chair itself. This allows one to 1) unfold the portable lift 2) attach the portable lift to the wheelchair 3) Use a means for activating the wheelchair lift motor for raising/lowering of the hoisting arm.

It is an object of the invention to provide a lighter lift for electric wheelchairs. Yet another object of the invention is to provide an alternative to a permanent lift mounted to a car. Yet another object of the invention is to provide a way for disabled individuals to use multiple non-lift mounted vehicles to pursue their activities. Yet another object of the invention is to pick up the chair from a lower vertex in order to add space and minimize height requirements. Yet another object of the invention is to keep the chair stable in a level position during lift and transportation. Yet another object of the invention is to enable people to take the device on an airplane, train or other public transportation and store it in an overhead compartment. An additional object of the invention is to minimize the occupied volume (via folding) that would otherwise be taken up with a portable lifting device.

### DESCRIPTION OF THE FIGURES

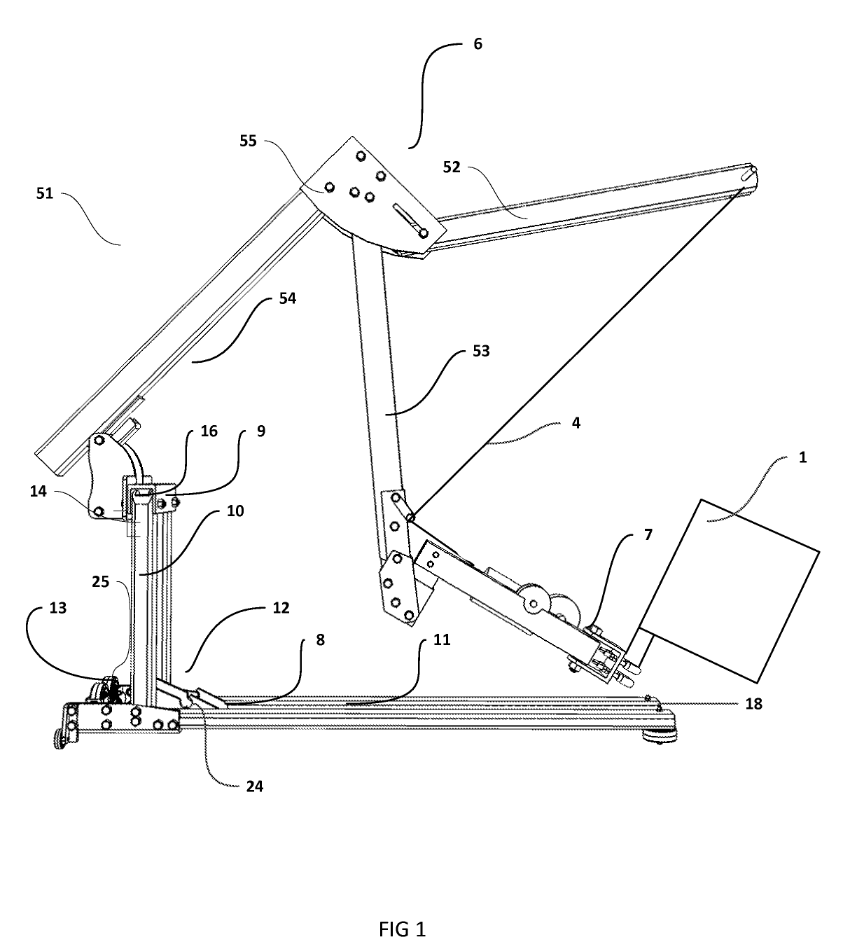

FIG. 1 is a perspective view which shows the portable lifting apparatus.
lifting assembly 6
belt 4
liftable object 1
chair motor assembly 7
base support piece 8
folding mechanism 9
base lateral arm 10
base forward arm 11
base forward lateral arm connection region 12
ground mobility mechanism 13
base arm connector region 14
base lateral arm connector 16
front caster 18
corner support latch 24
rear caster wheel 25
arm assembly 51
upper support arm 52
lifting arm 53
detachable lower support arm 54
assembly elbow 55

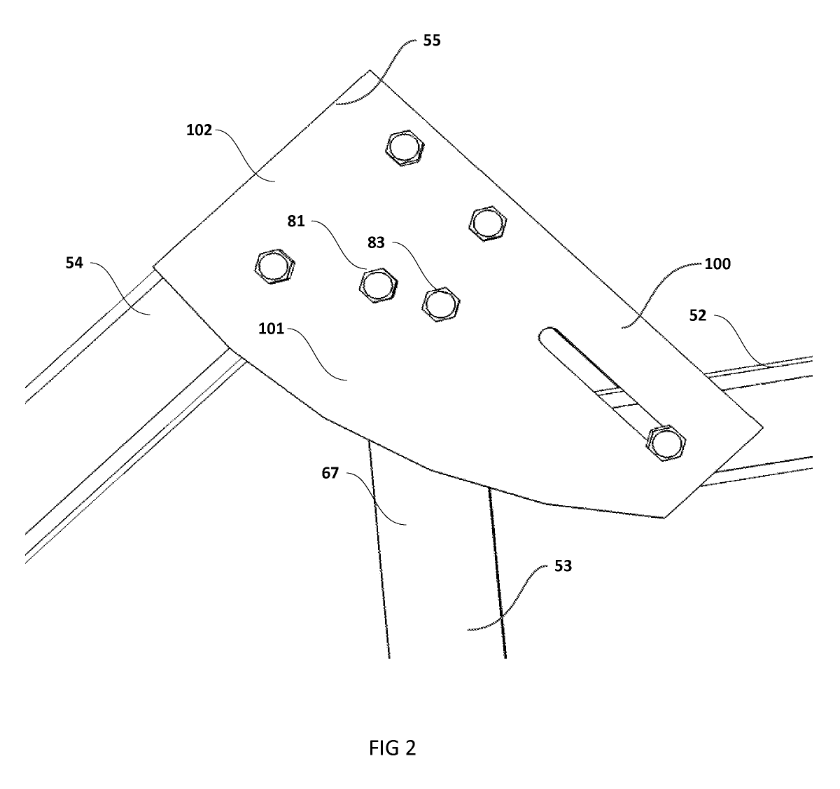

FIG. 2 is a perspective view which shows the assembly elbow that mediates the connection between the arms.
upper support arm 52
lifting arm 53
detachable lower support arm 54
assembly elbow 55
elbow end region 67
leveling rod pin aperture 81
lifting arm pivot pin 83
elbow upper arm region 100
elbow lifting Arm region 101
elbow support arm region 102

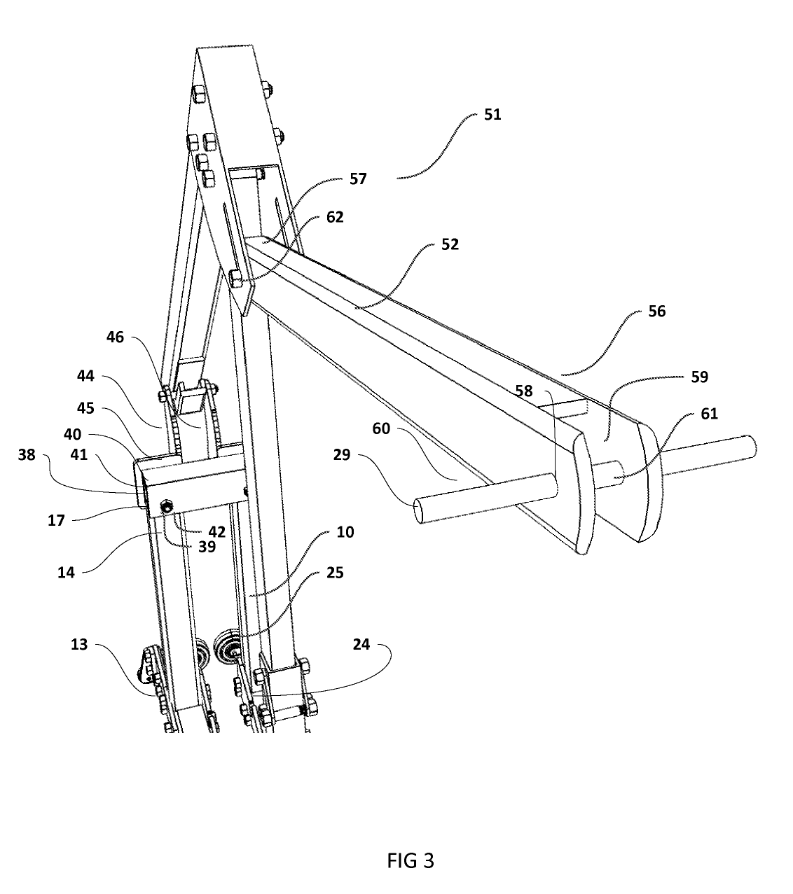

FIG. 3 is a perspective view which shows the end of the upper support arm.
base lateral arm 10
ground mobility mechanism 13
base arm connector region 14
pivot exterior buttressing surface 17
corner support latch 24
rear caster wheel 25
latch handles 29
lateral pivot aperture 38
ventral pivot aperture 39
connector interior buttress surface 40
connector interior buttress plate 41
pivot clearance aperture 42
perpendicular arm mounting flap 44
parallel connector mounting flap 45
arm insertion aperture 46
arm assembly 51
upper support arm 52
belt roller region 56
upper support elbow attachment region 57
belt roller insertion aperture 58
belt aperture 59
belt roller 60
roller bearing 61
upper arm pivot bolt 62

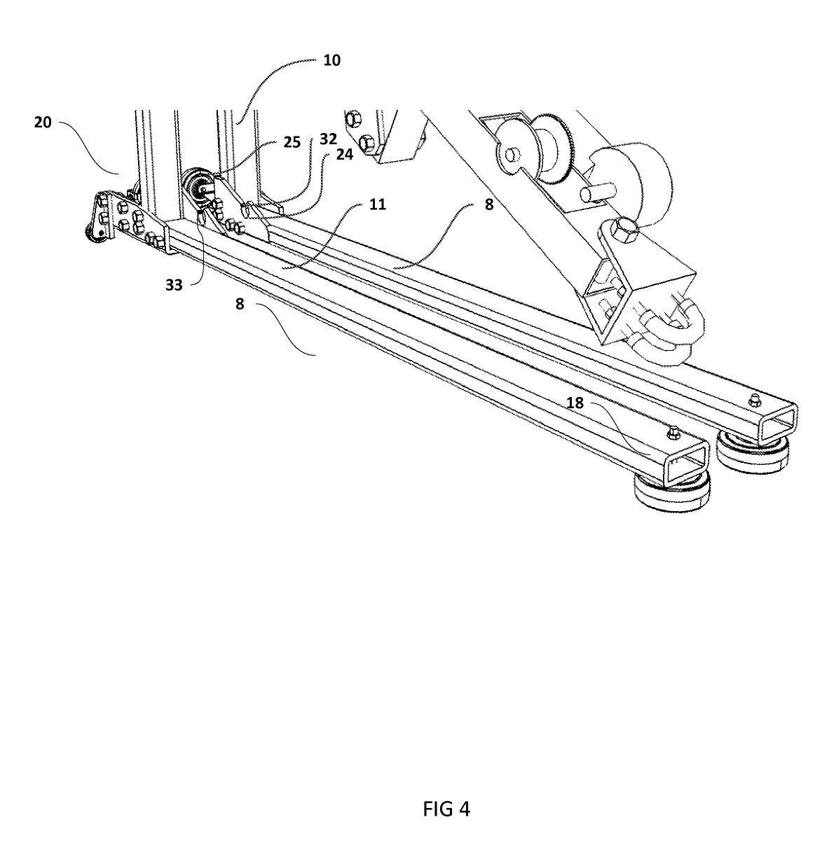

FIG. 4 is a perspective view which shows the collapsed base comprised of two equivalent base support pieces.
base support piece 8
base lateral arm 10
base forward arm 11
front caster 18
rear caster 20
corner support latch 24
rear caster wheel 25
corner Support Aperture 32
comber support catch 33

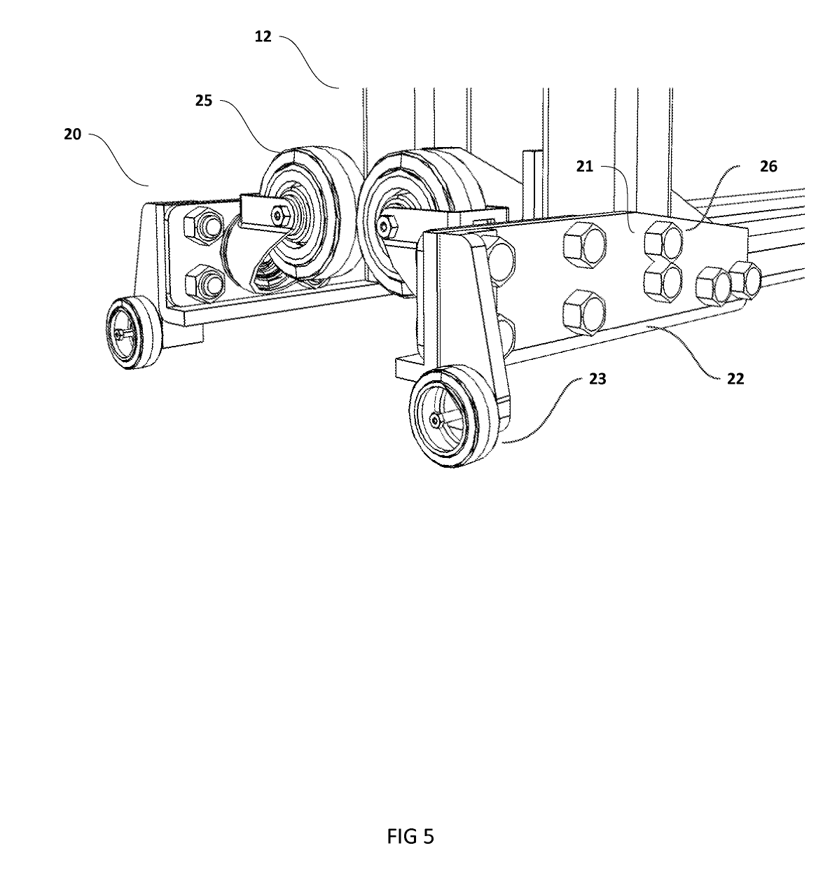

FIG. 5 is a perspective view which shows the rear mounts.
base forward lateral arm connection region 12
rear caster 20
corner caster mount region 21
corner caster mount region rounded edge 22
unfolding roller 23
rear caster wheel 25
corner caster mount region tapered edge 26

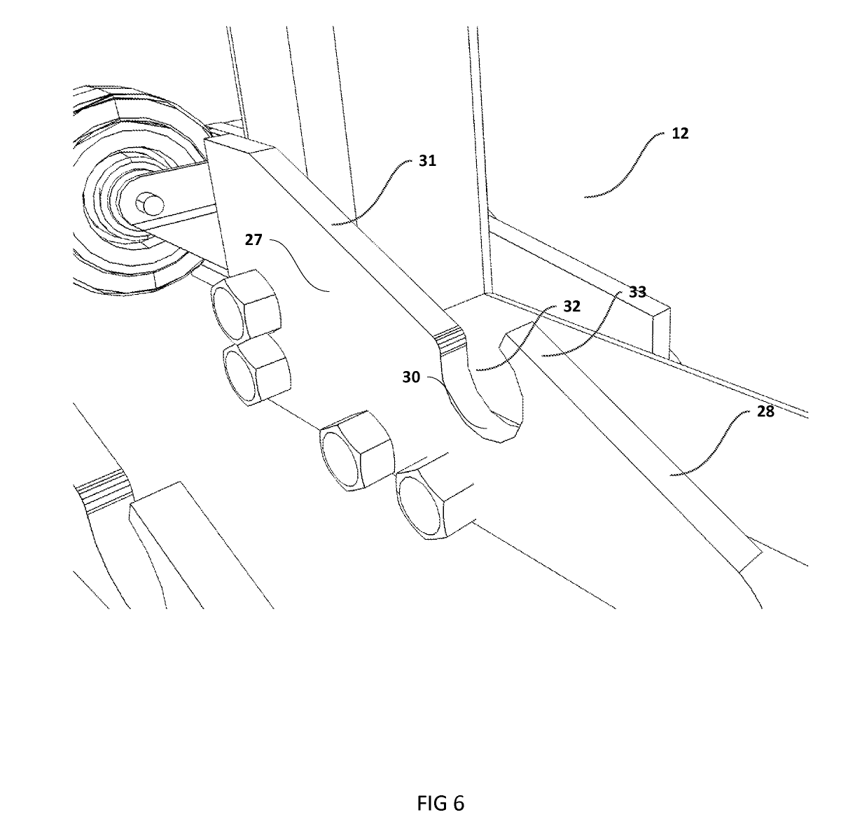

FIG. 6 is a perspective view which shows the folding latch where the handles fold into in the folding state.
base forward lateral arm connection region 12
corner support catch 27
corner support glide path 28
corner support aperture 30
corner support entry path 31
corner Support Aperture 32
comber support catch 33

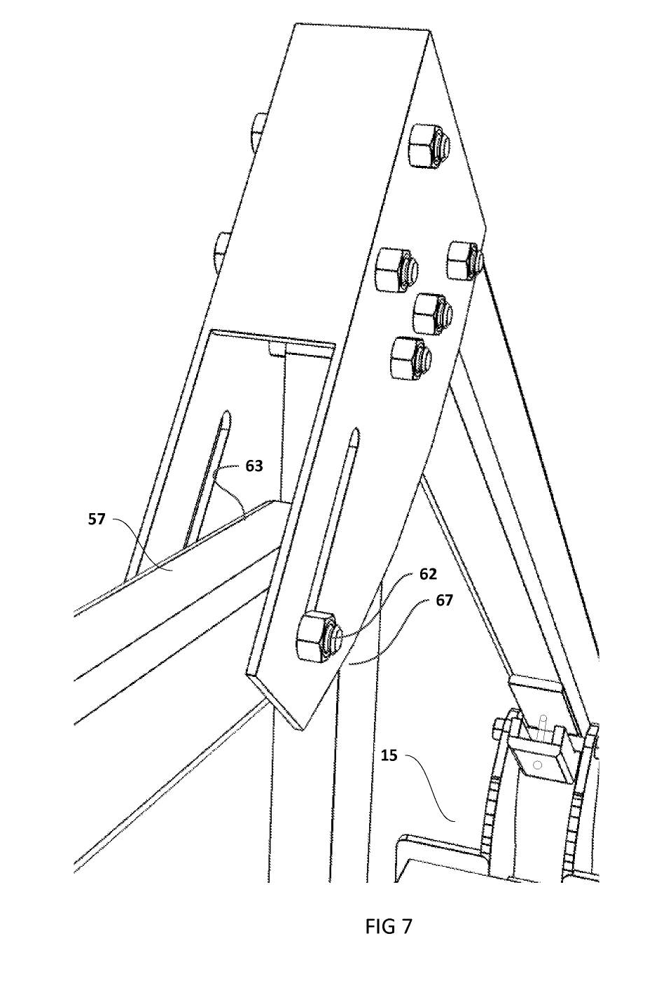

FIG. 7 is a perspective view which shows the proximal end of the upper support arm.
base arm connector 15
upper support elbow attachment region 57
upper arm pivot bolt 62
upper arm end 63
elbow end region 67

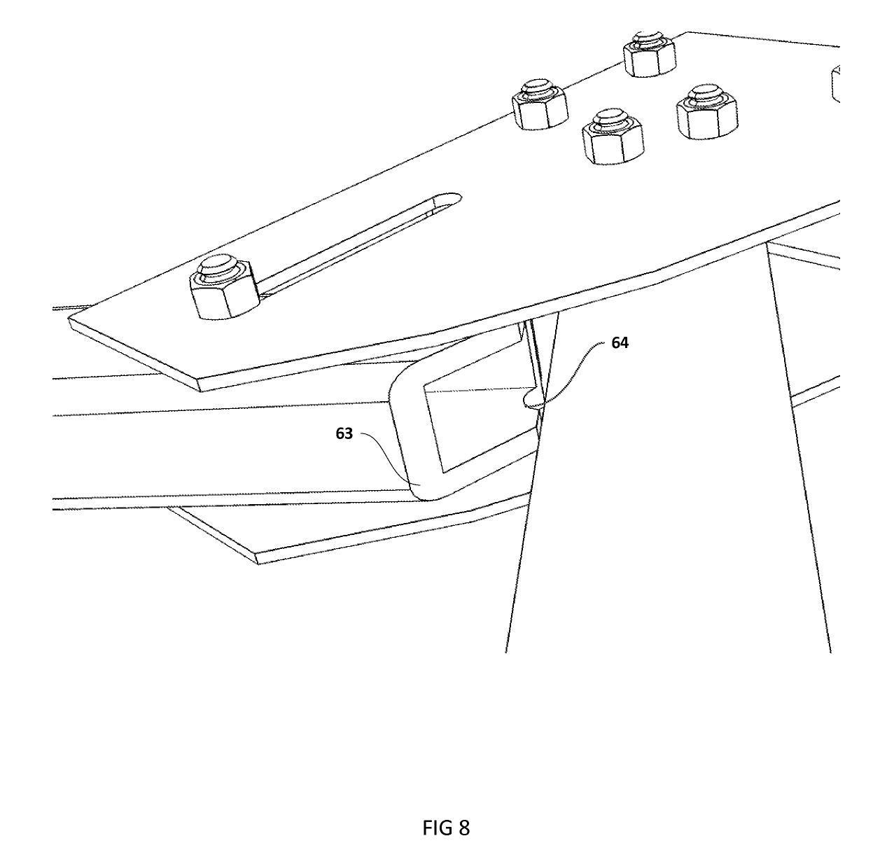

FIG. 8 is a perspective view which shows the edge of the proximal end of the upper
support arm.
upper arm end 63
upper arm groove 64

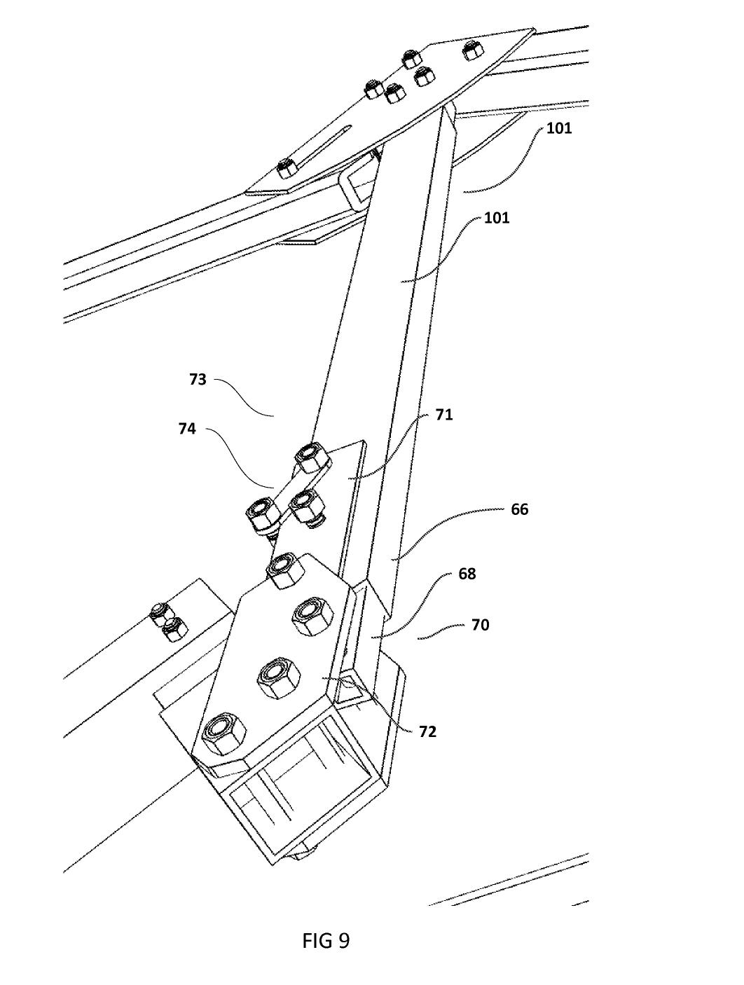

FIG. 9 is a perspective view which shows the lifting arm.
receiver end region 66
articulating mechanism 68
lift receiver assembly 70
receiver arm connection bracket 71
adjustment bracket 72
lift receiver assembly 73
belt connection assembly 74
elbow lifting Arm region 101

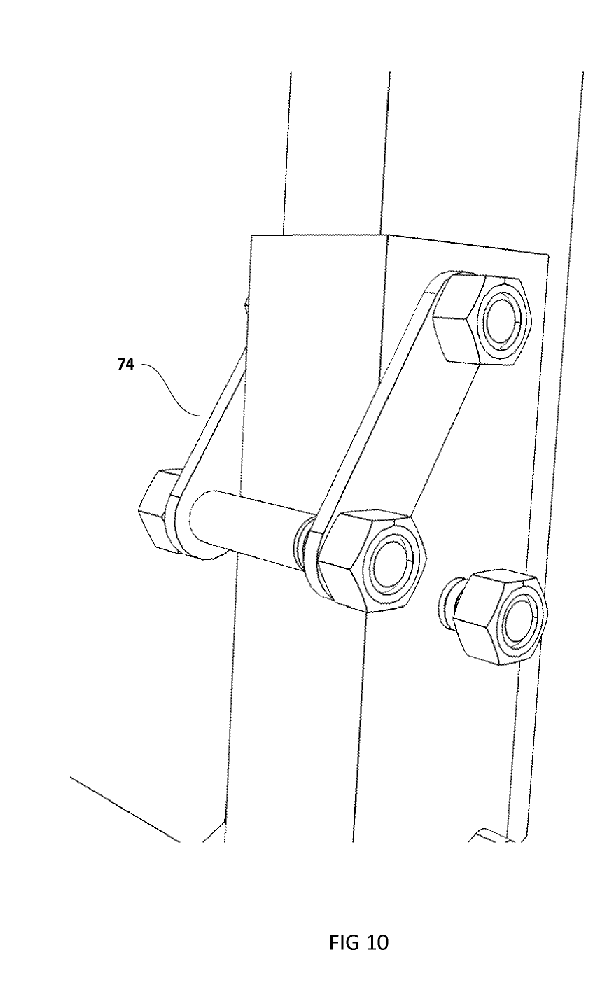

FIG. 10 is a perspective view which shows the belt connection assembly.
belt connection assembly 74

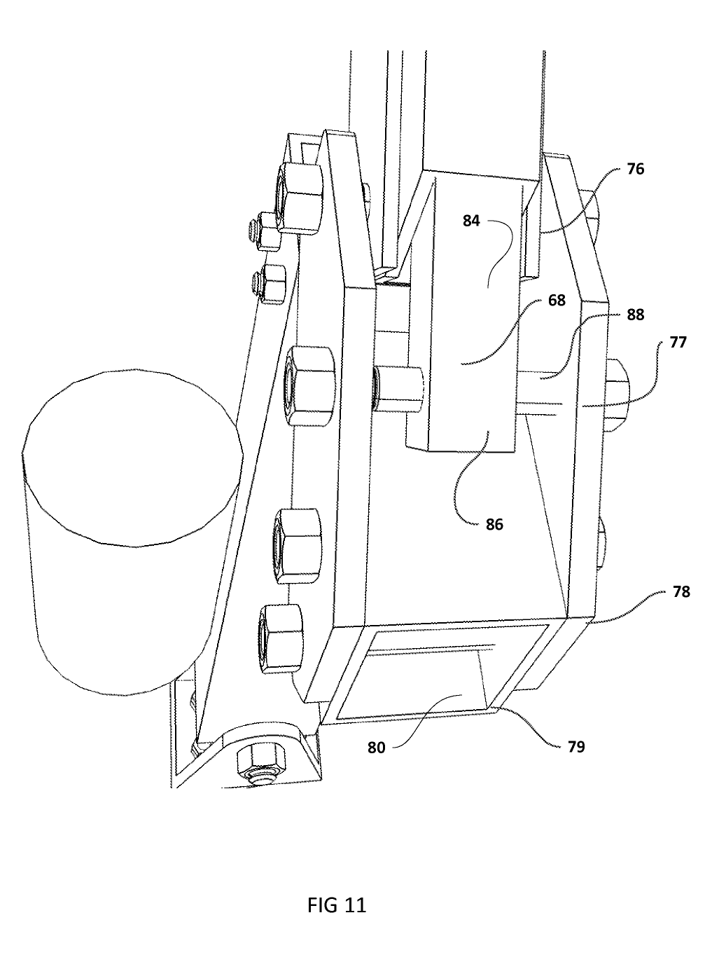

FIG. 11 is a perspective view which shows the receiving collar attachment region.
articulating mechanism 68
receiving collar attachment region 76
leveling rod region 77
lifting arm region 78
receiving collar 79
collar stem aperture 80
self leveling rod 84
receiver attachment region 86
receiver rod pin 88

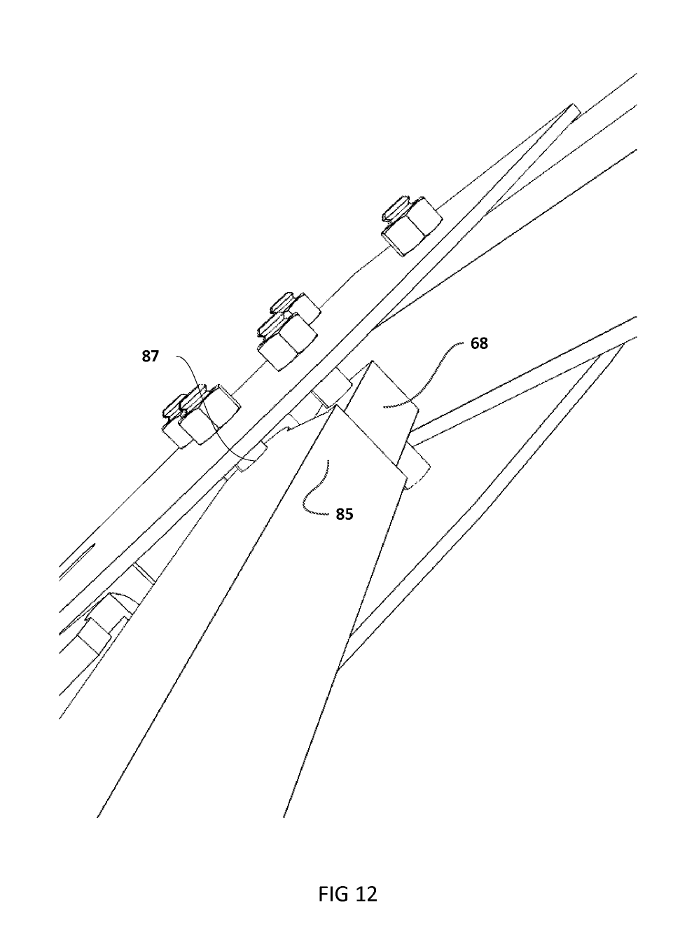

FIG. 12 is a perspective view which shows the proximal end of the lifting arm.
articulating mechanism 68
elbow rod attachment region 85
elbow rod pivot pin 87

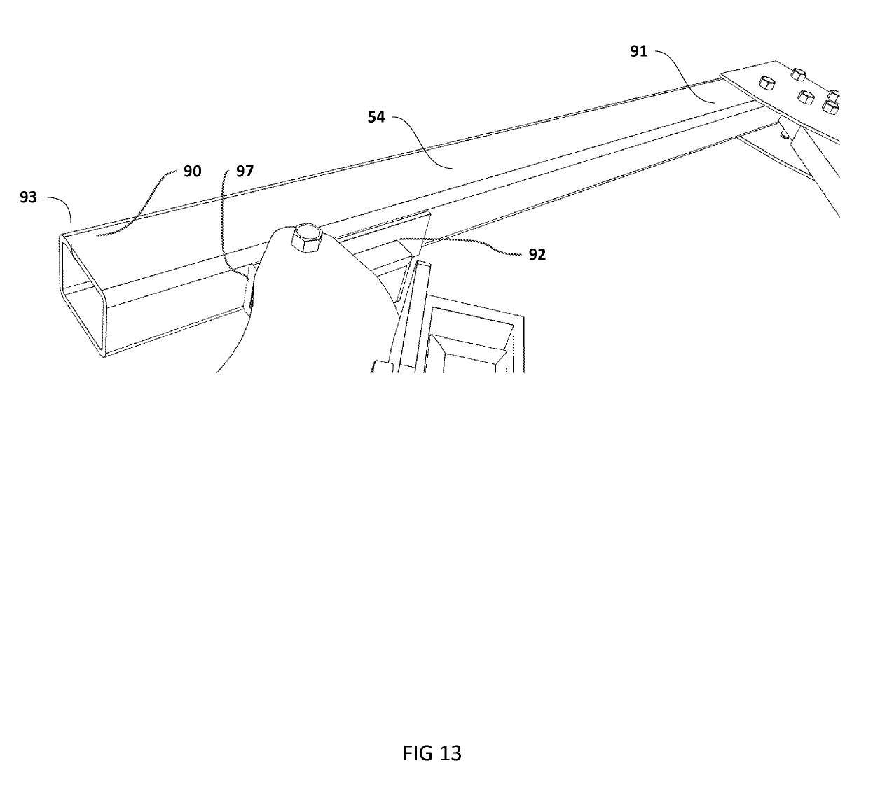

FIG. 13 is a perspective view which shows the detachable lower support arm.
detachable lower support arm 54
no load support region 90
lower support end region 91
locking mechanism 92
no load end 93
locking mechanism lower support arm attachment region 97

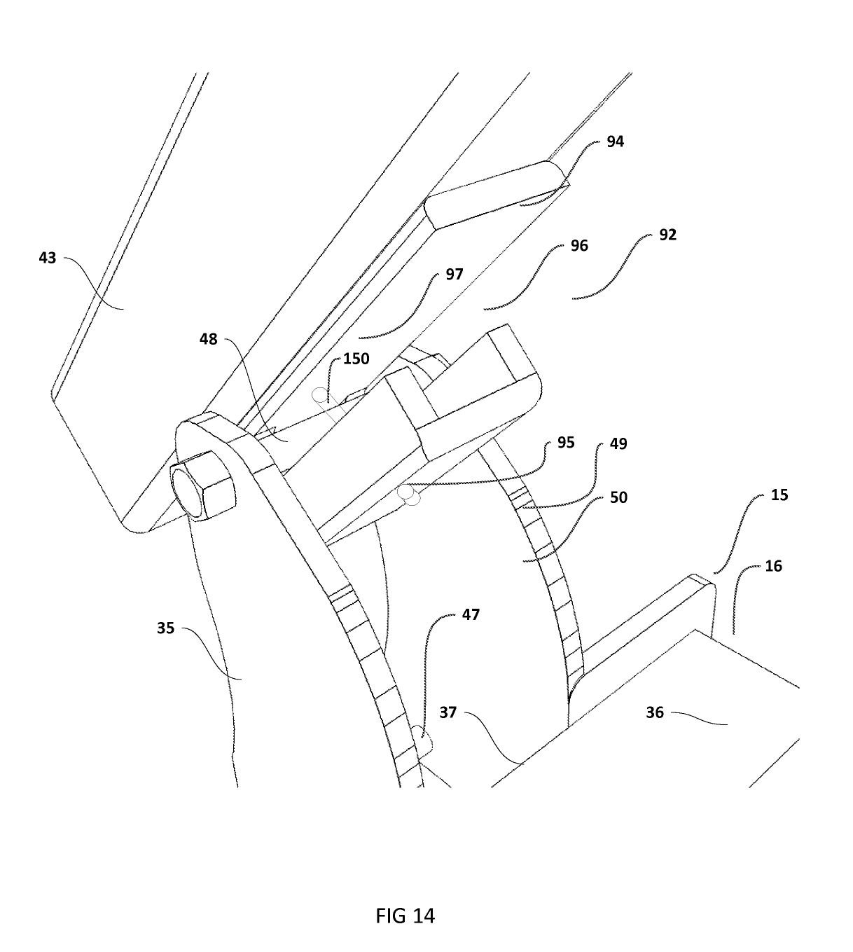

FIG. 14 is a perspective view which shows the locking mechanism.
base arm connector 15
base lateral arm connector 16
lower arm mount 35
base lateral arm pivot region 36
middle no load mounting surface 37
lower support arm 43
bottom mounting pin 47
top mounting pin 48
curved mounting edge 49
perpendicular interior surface 50
locking mechanism 92
top region 94
locking pin 150
locking pin aperture 95
locking pin sliding groove 96
locking mechanism lower support arm attachment region 97

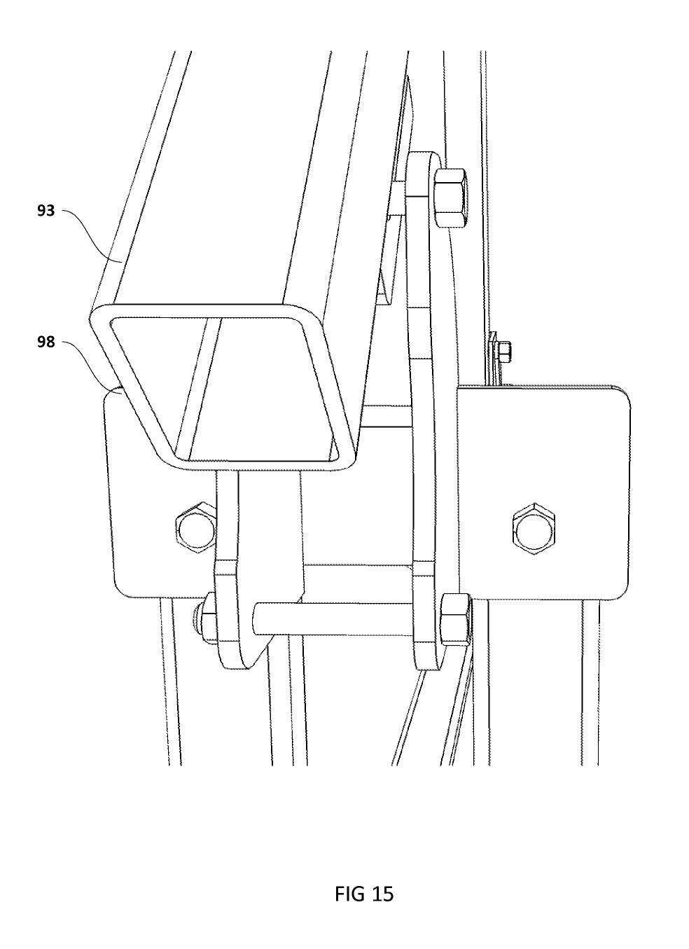

FIG. 15 is a perspective view which shows the edge of the lower support arm.
no load end 93
floor clearance angle edge 98

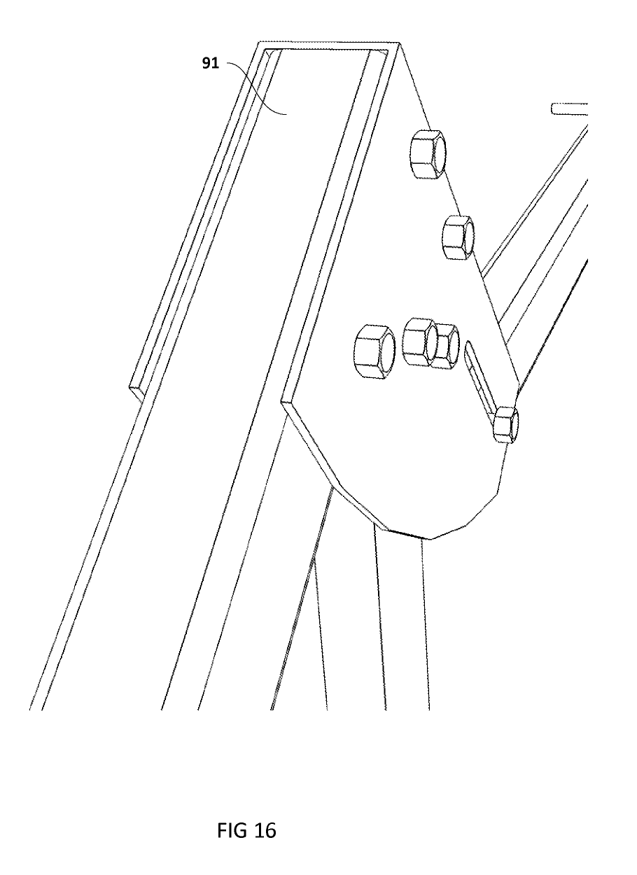

FIG. 16 is a perspective view which shows the top portion of the lower support arm.
lower support end region 91

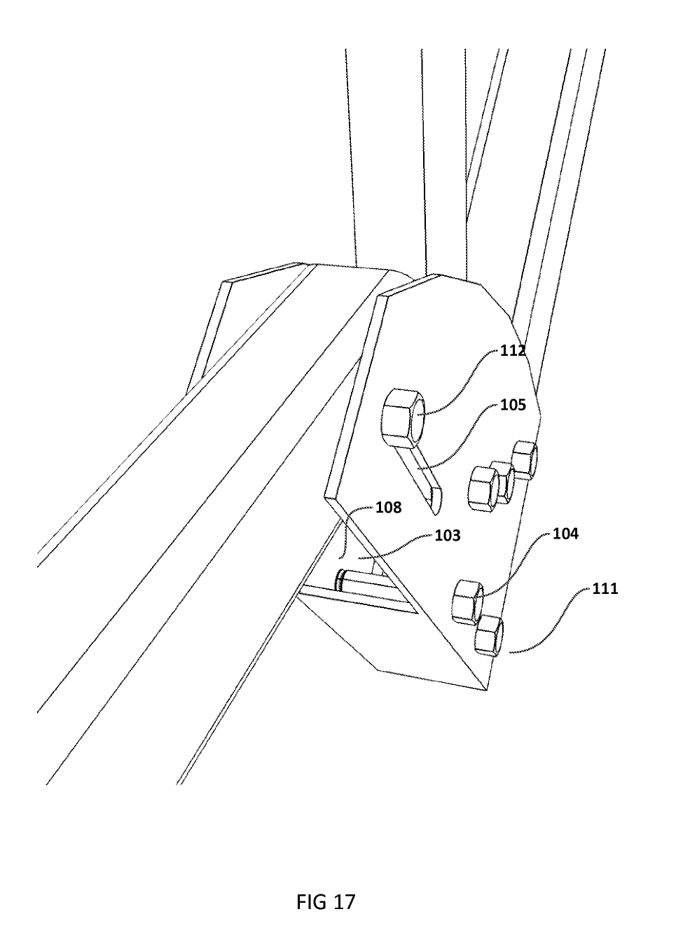

FIG. 17 is a perspective view which shows interior portions of the assembly elbow.
upper arm support sleeve 103
upper arm support sleeve pivot slot 105
support sleeve back aperture 108
support sleeve bottom aperture 111
support sleeve pin 112

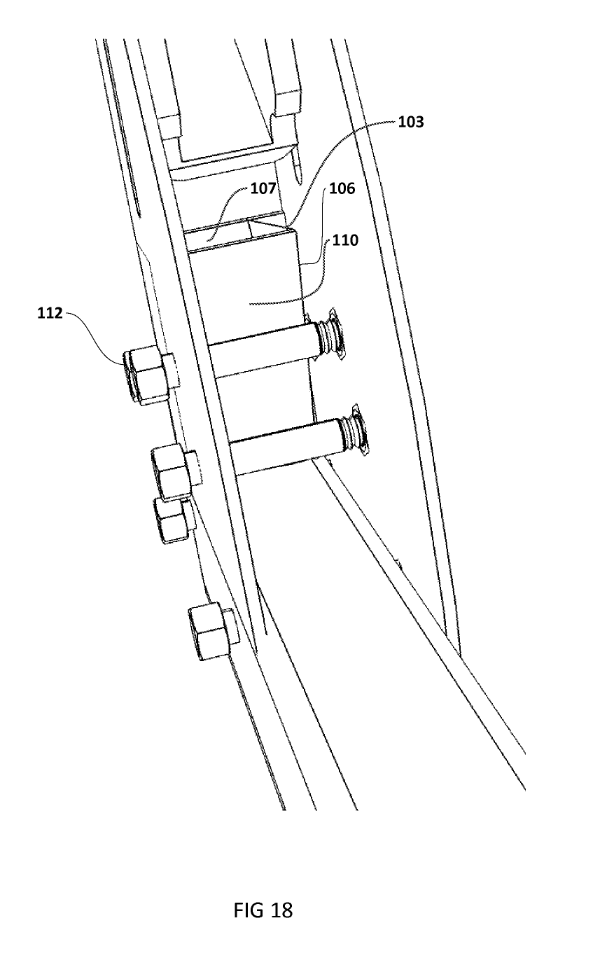

FIG. 18 is a perspective view which shows the sleeve portion of the assembly elbow (with the lifting arm removed for clarity).
upper arm support sleeve 103
support sleeve elbow surface 106
support sleeve top aperture 107
support sleeve front plate 110
support sleeve pin 112

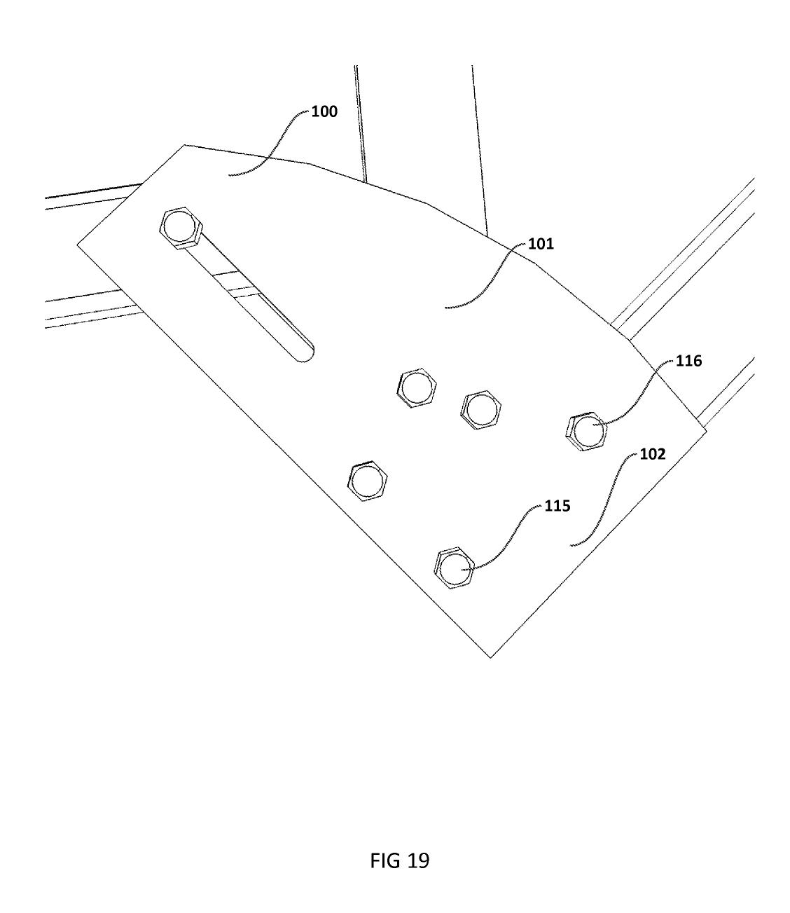

FIG. 19 is a perspective view which shows the regions of the assembly elbow.
elbow upper arm region 100
elbow lifting Arm region 101
elbow support arm region 102
elbow attachment forward bolt 115
elbow attachment back bolt 116

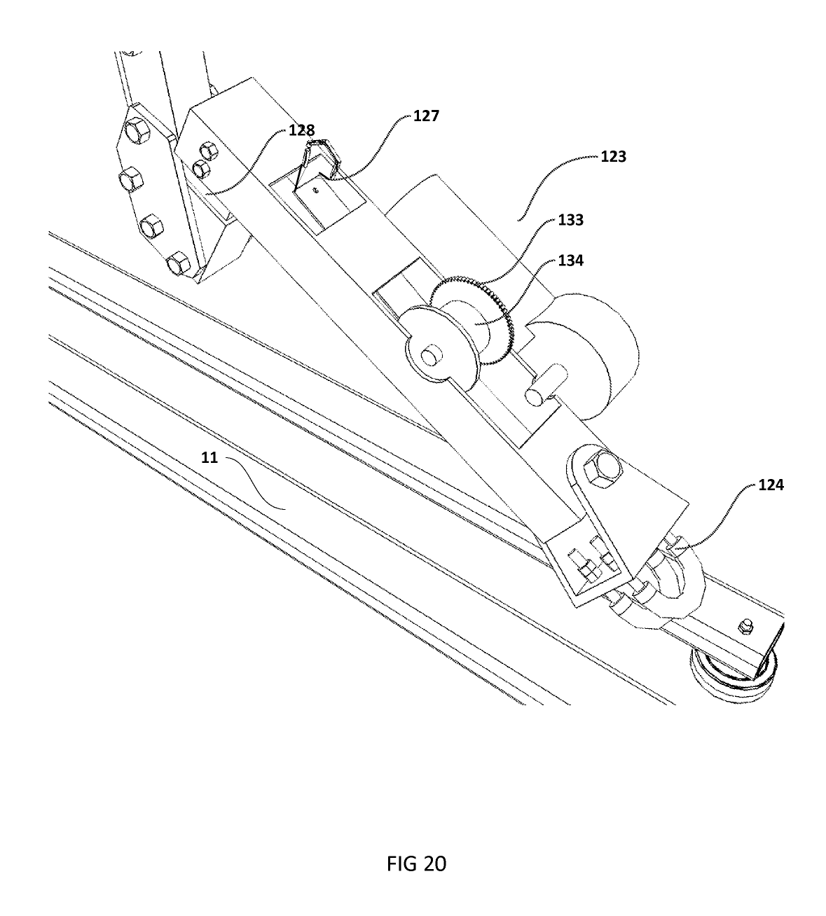

FIG. 20 is a perspective view which shows the chair motor assembly.
base forward arm 11
motor assembly 123
connection bracket pivot 124
belt holder 127
stem 128
belt sprocket 133
belt spool 134

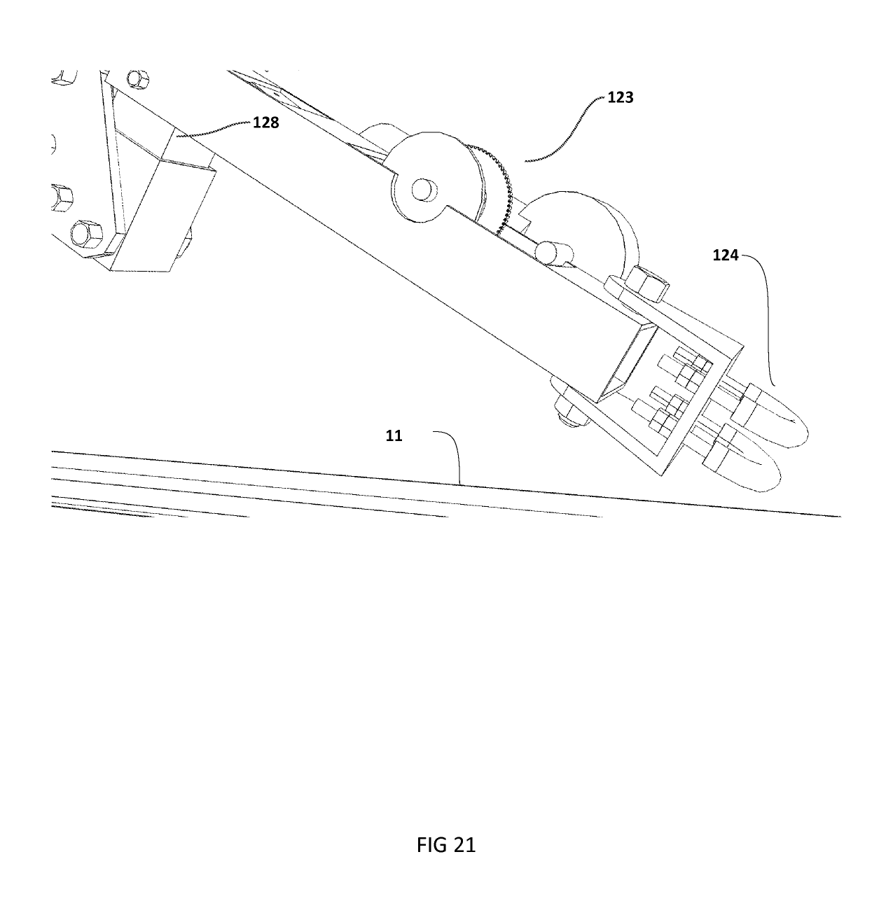

FIG. 21 is a perspective view which shows the connection bracket.
base forward arm 11
motor assembly 123
connection bracket pivot 124
stem 128

### DETAILED DESCRIPTION OF THE INVENTION

A general method for using the invention preferably involve several steps: (i) To begin, a person acquires the portable lifting apparatus. (ii) Next, a person stores the lifting apparatus in its folded state. (iii) Then, after detecting the need for use of the apparatus, the person transports the apparatus to the an area near the device to be lifted. (iv) Next, a person manipulates the invention into the unfolded state. (v) Then, a person positions the lifting apparatus so that it operably interacts with the object to be lifted. (vi) Next, a motor (present either on the lifting apparatus or device to be lifted; or manual manipulation) raises the object into suspension. (vii) Next, one or more articulations, combined with movements of the base, maneuver the object lifted. (viii) Next, upon desire to detach the object, the object is positioned near its target area. (ix) Then, a motor (present either on the lifting apparatus or device to be lifted; or manual manipulation) lowers the object near the target area. (x) Then, once stable, the portable apparatus detaches from the object. (xi) And last, a person may choose to return the portable lifting apparatus to its folded state for storage. The above method is herein identified as method 500 and while these steps are depicted in an order, it is thought that these steps may be performed in one or more alternative orders.

The invention has some elements that are commonly known, however their use and relationships to the novel components and steps of the invention render them applicable herein. In order to highlight the roles in the specification, they are subsequently explained here: A liftable object 1 comprises an object that is heavy enough for the operator of the lifting apparatus, that it would be desirable to not lift the object manually. In some embodiments, one may reason that examples of an liftable object 1 may include a powered wheel chair, scooters, coolers, groceries, a toolbox, or lawn equipment. An electrical power source 2 comprises a device that delivers electrical energy to perform work. In some embodiments, one may reason that examples of an electrical power source 2 may include, a battery, AC power, DC power, solar power, or wind power. The electrical control source 3 comprises a device or system that controls its operation. In some embodiments, one may reason that examples of an electrical control source 3 may include a wired hand controller, a wireless remote controller, a smartphone control, a wifi control, or a bluetooth control. In some embodiments, it is reasonable to contemplate that examples of a belt 4 may include belt-like devices, for example, chains. In some embodiments, one may reason that examples of a motor 5 may include an electrical motor, a compressed air motor, a drill, or hydraulics.

Overall the invention can be viewed as several interactive sub-items which grossly include; a base, a lifting assembly 6, and a chair motor assembly 7. In a preferred embodiment, the base is preferably situated beneath the lifting assembly 6. The base can also be collapsed on itself in the folded state, and immediately above a stabilizing surface (such as the ground) in the active state. The base is designed to both 1) support the lifting assembly 6 and to 2) allow mobility for moving an object that is being lifted. In the main embodiment of the invention, the base is chiefly contemplated to be created from aluminum but other embodiments may be composed of some of the following materials: steel, composite, or carbon-fiber. In the preferred embodiment, the base includes two sub-items, the base support piece 8, and the folding mechanism 9, respectively.

Examples of a base support piece 8 may 1) include a removable platform, that allows one to lift alternate things besides a chair, 2) may include motorized wheels and perhaps remote guidance of the base, so that one may not move it manually, or 3) may include means for steering the base, then locking the base, and which provides a stable platform (with rails) for moving the chair in a specific direction (without using the wheels in the base). In some embodiments, one may reason that if the base support piece 8 is absent, than a tripod assembly may suffice for support. The base support piece 8 preferably comprises, a base lateral arm 10, a base forward arm 11, a base forward lateral arm connection region 12, and a ground mobility mechanism 13.

In a preferred embodiment, the base lateral arm 10 is preferably positioned near the lifting assembly 6 and perpendicular to the base forward arm 11. The base lateral arm 10 has several aims which are as follows: First, the purpose of the base lateral arm 10 is that it connects the base forward arm 11 and the lifting mechanism. Next, it provides width and stability to the lift. Finally, it aims to form an area that allows folding of the arm assembly for transport. In some embodiments, one may reason that an example of a base lateral arm 10, may be a telescoping lateral base arms. Further, the base lateral arm 10 preferably comprises a base arm connector region 14.

The base arm connector region 14 comprises the medial end of the base arm connector region 14. The base arm connector region 14 is designed to both 1) bind to the base lateral arm connector 16 and to 2) provides a pivot region, for folding and unfolding. Further, the base arm connector region 14 preferably comprises an additional sub-component herein termed the pivot exterior buttressing surface which comprises the top surface of the arm and interacts with the plate on the connecting region. One goal of the pivot exterior buttressing surface 17 is to provide a support surface, so that when the base is in the open position it can bear the load of both the lift and the chair.

In the preferred embodiment, the base forward arm 11 is preferably positioned perpendicular to the base lateral arm 10 and beneath the lifting assembly 6. The base forward arm 11 has several intents which are as follows: First, the purpose of the base forward arm 11 is that it provide stability. Next, another purpose is to have a length long enough to provide a cantilever balance, allowing it to fit underneath raised structures such as automobiles. In some embodiments, one may reason that an example of a base forward arm 11 may include telescoping forward arms. In addition, the base forward arm 11 preferably comprises the front mount 18.

The front mount 18 comprises a mechanism for moving the base along a surface upon which it rests. It is preferably positioned on the apical end of the forward arm. It has several intents which are as follows: First, the purpose of the front mount 18 is to provide maneuverability. Next, another purpose is to bear the load of the chair and lift. Lastly, the contact surface points should have a soft surface (such as rubber), so that the metal of the base forward arm 19 does not scrape a floor when collapsed. In some embodiments, it is reasonable to contemplate that an example of a front mount 18 may include a ball roller, sliders, or motor driven wheels.

The base forward lateral arm connection region 12 is preferably positioned in between the base lateral arm 10 and base forward arm 11. One goal of the base forward lateral arm connection region 12 is to bind the base lateral arm 10 and base forward arm 11. In some embodiments, an example of a base forward lateral arm connection region 12 may include a foldable joint so that the forward legs and lateral legs can collapse.

The ground mobility mechanism 13 is positioned between the forward and lateral arms and comprises a structure that has both a mobility mechanism and an unfolding/folding mechanisms. In some embodiments, one may reason that if the ground mobility mechanism 13 is absent, than there may be a fixed support, such that no wheels or casters exist and a pivot motion of the arms will allow for swinging in order to enhance mobility. The ground mobility mechanism 13 preferably comprises a rear mount 20.

The rear mount is a general term for the components that bind together the base lateral arm and base forward arm, and the lift, to the mobility mechanisms that allow its operation. The rear mount 20 preferably includes a corner caster mount region 21, a corner caster mount region rounded edge 22, an unfolding roller 23, a corner support latch 24, and a rear mount wheel 25.

The corner caster mount region 21 comprises the region that serves as a substrate for connecting the various components together of the rear mount 20. The corner caster mount region 21 is preferably positioned around the joint of the lateral and forward arms and encompasses them. One goal of the corner caster mount region 21 is to bind to the base forward arm 11 and base lateral arm 10. Further, the corner caster mount region 21 preferably comprises a corner caster mount region tapered edge 26, which prevents a sharp edge from interacting with the user.

The corner caster mount region rounded edge 22 is preferably positioned outside and wrapping the forward arm. The corner caster mount region rounded edge 22 is designed to both 1) make it smoother so that it does not interact with the user and to 2) adds strength to the rear mount.

In the preferred embodiment, the unfolding roller 23 is preferably positioned behind the rear mount wheel 25 and (on the ground) when invention is in the process of being folded. The unfolding roller 23 has several aims which are as follows: First, the unfolding roller 23 allows the legs to expand without the user having to bend over. It also keeps metal from the arms from scraping on the ground. Lastly, its placement and motion, allow it to be “auto-unfolding” to a user. Alternative examples of an unfolding roller 23 might be, a ball roller or sliders.

The corner support latch 24 is preferably positioned on the inside of the forward arm. The corner support latch 24 is designed to both 1) provide structural support for the corner and to 2) provide latch when in folded position. If corner support latch 24 is absent, one can contemplate that the forward arms may attach to one another. Or perhaps, that the lateral arms may attach to one another. Or perhaps there is another mechanism that may mediate a connection between the forward arms and/or lateral arms. In the preferred embodiment, the corner support latch 24 preferably comprises a corner support catch 27, and a corner support glide path 28, respectively.

The corner support catch 27 is preferably positioned opposite the glide path. It is designed to both 1) lock to the latch handles 29 and to 2) bind the base lateral arm 10 and base forward arm 11. In some embodiments, an example of a corner support catch 27 may be a magnetic catch and the like. In a preferred embodiment, the corner support catch 27 preferably comprises a corner support aperture 30, and a corner support entry path 31, respectively. One goal of the corner support aperture 30 is to encompass the latch handles 29 so that when folded it will catch and lock in the folded position so that it can be lifted.

The corner support entry path 31 is preferably positioned before the corner support aperture 30. One goal of the corner support entry path 31 is to guide the latch handles 29 upon folding so that they enter the corner support aperture 32. In turn, the corner support glide path 28 is preferably positioned on the edge of the latch. It helps when folding the invention, such that the latch handles 29 will be guided over the corner support catch 33 and it can be put into a locking position.

In a preferred embodiment, the rear mount wheel 25 is preferably situated forward of the unfolding roller 23, where it touches the ground (in the unfolded state), and is present on the bottom side of the arms. The rear mount wheel 25 has several intents which are as follows: First, the purpose of the rear mount wheel 25 is to roll the lift when in use. Next, it aids the unfolding roller 23 in unfolding the invention. Next, another purpose is to maneuver and steer the lift with the help of the front mount 18, while the chair is in the lifted state. Lastly, it should be sturdy enough to bear the weight of the chair and lift. In some embodiments, it is reasonable to contemplate that an example of a rear mount wheel 25 may also be a ball roller, sliders, or motor driven wheels.

The folding mechanism 9 comprises a physical means to connect the different arm types and also provide a mechanism to fold the device. In the preferred embodiment, it is preferably positioned between the lateral arms and below the lifting assembly. In some embodiments, examples of a folding mechanism 9 may be a joint folding mechanism that does not have base lateral arm connector 16, u-joints, ball joints, ball joint assembly with folding tripod legs, or u-joint assembly with folding tripod legs.

It is also not necessary that the folding mechanism 9 be used. In some embodiments, one may reason that if the folding mechanism 9 is absent, than there may be solid single lateral arm and folding may occur in the arms, with our without telescoping. In other instances, if folding mechanism 9 is absent than arms of the base may be disconnectable, for storage and or transportation. The folding mechanism 9 preferably comprises a base arm connector 15 to connect the arm to the base via the lower support arm 43. In turn, the base arm connector 15 preferably comprises a base lateral arm connector 16, and a lower arm mount 35, respectively.

The base lateral arm connector 16 has several intents which are as follows: First, the purpose of the base lateral arm connector 16 is that it is a means by which the base support pieces 8 bind to each other. Next, another purpose is to allow a pivot for folding and unfolding. Finally, it aims to provide load bearing support for the invention.

In some embodiments, one may reason that if the base lateral arm connector 16 is absent, than there may be a direct connection between the two lateral arms and it could be folded on a joint. In the preferred embodiment, the base lateral arm connector 16 preferably comprises a base lateral arm pivot region 36, and a middle no load mounting surface 37, respectively. One goal of the base lateral arm pivot region 36 is to have a convenient way to fold and unfold the device. The middle no load mounting surface 37 is designed to both 1) act as a support when there is no load and to 2) function as a stop for the lower support arm 43 when there is no load.

The base lateral arm pivot region 36 preferably comprises a lateral pivot aperture 38, a ventral pivot aperture 39, a connector interior buttress surface 40, and a connector interior buttress plate 41. One goal of the lateral pivot aperture 38 is to bind to the lateral arm via a pin and allow rotation when folding and unfolding in concert with the ventral pivot aperture. One goal of the ventral pivot aperture 39 is to bind to the lateral arm via a pin and allow rotation when folding. One goal of the connector interior buttress surface 40 is to support the end of the base lateral arm 10 when in the open position and bear the load of the weight of the chair and lift. One goal of the connector interior buttress plate 41 is to mediate the load off of the buttress surface and support the end of the base lateral arm 10 when in the open position.

Further, the ventral pivot aperture 39 preferably comprises an additional sub-component herein termed the pivot clearance aperture 42 which allows clearance of the base lateral arm 10 when folding and unfolding.

As part of the base arm connector, the lower arm mount 35 preferably comprises a perpendicular arm mounting flap 44, a parallel connector mounting flap 45, an arm insertion aperture 46, a bottom mounting pin 47, and a top mounting pin 48. The perpendicular arm mounting flap 44 extends off the base piece and creates the aperture where the arm assembly attaches to the base. In the preferred embodiment, the perpendicular arm mounting flap 44 preferably comprises a curved mounting edge 49 (prevent user interaction with sharp edges), and a perpendicular interior surface 50, respectively. The perpendicular interior surface 50 is designed to both 1) prevent the arm from moving side to side and to 2) limit the range of motion of the arm to up and down. The parallel connector mounting flap 45 is designed to both 1) primarily bear the load of the device and to 2) attach the perpendicular arm mounting flap 44 to the base pieces. One goal of the arm insertion aperture 46 is to have a region where the lower support arm 43 inserts. One goal of the bottom mounting pin 47 is to acts as a wedge when the lift is under load.

The top mounting pin 48 has several intents which are as follows: It provides a pin for the locking mechanism. Next, another purpose is to acts as a weight bearing when under load. Next, another purpose is that it allows one to unlock the entire base. Lastly, it also serves to acts as a weight bearing mechanism when carrying the device.

The lifting assembly is a main component of the invention. The lifting assembly 6 is preferably positioned above the base. In the main embodiment of the invention, the lifting assembly 6 is chiefly contemplated to be created from aluminum but other embodiments may be composed of some of the following materials: steel, composite, or carbon-fiber. Further, the lifting assembly 6 preferably comprises an arm assembly 51, an array of arms used in the invention including the upper support arm 52, the lifting arm 53, the detachable lower support arm 54, and the assembly elbow 55.

In the preferred embodiment, the upper support arm 52 is preferably positioned above the lifting arm and is at the highest apex of the apparatus. The upper support arm 52 has several intents which are as follows: First, the purpose of the upper support arm 52 is that it mediates the height needed to raise the liftable object. Further, it helps to guide the lift. Next, another purpose is to allows a back stop support for which closes the lifting arm to the upper support arm when the belt is in action. Next, another purpose is to allows clearance over a trunk edge. Lastly, it also serves to allows one to get further into a vehicle with the chair. In some embodiments, one may reason that an example of an upper support arm 52 may be a two piece assembly that perches out like a “T”. If upper support arm 52 is absent, one can contemplate that there are alternatives. For example, in its absence a motor winch combination may raise and lower the lifting arm only, while using the lower support arm for support. Further, it is possible that in its absence a hydraulic lift may be used with the lower support arm. Finally, if absent then a screw drive may be used to operate the movement. In the preferred embodiment, the upper support arm 52 includes two sub-items, the belt roller region 56, and the upper support elbow attachment region 57, respectively.

The belt roller region 56 FIG. 3 is preferably positioned at the apical end of the upper support arm 52. One goal of the belt roller region 56 is to provide a means for a belt rotation point in order to lift the chair. It is also not necessary that the belt roller region 56 be used. In some embodiments, one may reason that if the belt roller region 56 is absent, than then a motor may be attached in order to operate a winch (motor winch assembly). In other instances, if belt roller region 56 is absent than a winch alone may be operated by a drill. In the preferred embodiment, the belt roller region 56 preferably comprises a belt roller insertion aperture 58, and a belt aperture 59, respectively.

The belt roller insertion aperture 58 is preferably positioned centrally within the belt roller region 56 and supports the belt roller 60. Further, the belt roller insertion aperture 58 preferably comprises a belt roller 60 within it. The belt roller 60 is preferably positioned through the belt roller insertion aperture 58 and is comprised of a roller bearing 61, and latch handles 29, respectively.

In the preferred embodiment, the roller bearing 61 is preferably positioned inside the belt roller 60 and within the latch handles 29. The roller bearing 61 aims to have a smooth surface so it doesn't cause wear on the belt. Further, it aims to be freely rotating in order for the belt to move. It also aims to accommodate a belt with enough width to lift the object that is desired to be lifted. The latch handles 29 are preferably positioned outside the belt aperture 59. One goal of the latch handles 29 is to lock in to the locking mechanism. The belt aperture 59 is preferably positioned adjacent to the belt roller insertion aperture 58 and is designed to both 1) have a region where the belt can wrap around the belt roller 60 and to 2) accommodate a wide enough belt in order to lift the chair.

The upper support elbow attachment region 57 FIG. 7 is preferably positioned at the proximal end of the upper support arm 52. In the preferred embodiment, the upper support elbow attachment region 57 includes two sub-items, the upper arm pivot bolt 62, and the upper arm end 63, respectively.

The upper arm pivot bolt 62 is preferably positioned within the elbow region. The upper arm pivot bolt 62 has several intents which are as follows: First, the purpose of the upper arm pivot bolt 62 is that it allows it to be folded. Next, another purpose is to allows it slide down in the load bearing position. Lastly, it also serves to be lockable when rotating the arm assembly 51 into the collapsed state.

The upper arm end 63 FIG. 8 is preferably positioned at the end of the upper support elbow attachment region 57. and preferably comprises the upper arm groove 64. The upper arm groove 64 is preferably positioned on the tip of the upper arm end 63. One goal of the upper arm groove 64 is to insert on the bottom mounting pin 47 when in open position.

In the preferred embodiment, the lifting arm 53 FIG. 9 is preferably positioned beneath the upper support arm 52 and above the detachable lower support arm 54. The lifting arm 53 is designed to both 1) have an attachment support to mediate the interaction between the upper support arm, belt and chair receiver and to 2) to actuate and guide the lifting process. In some embodiments, one may reason that if the lifting arm 53 is absent, than the chair may be hoisted and suspended like a crane lift with only the upper support arm, lifted by a motor. The lifting arm 53 has sub-components: preferably comprises a receiver end region 66, the elbow end region 67, and the articulating mechanism 68.

The receiver end region 66 FIG. 9 is preferably positioned at the receiver end of the arm. One goal of the receiver end region 66 is to house the lift receiver assembly 70. Further, the receiver end region 66 preferably comprises the lift receiver assembly 70 which is preferably positioned on the apical end of the receiver end region 66 and surrounding the arm itself. The lift receiver assembly 70 has several intents which are as follows: First, the purpose of the lift receiver assembly 70 is to perform the main articulating functions of the inventions. Next, another purpose is to provide the contact points between the object to be lifted and the lift. Next, another purpose is to mediate the connections between the belt, support arm and the chair to be lifted. Finally, it aims to house the leveling rod arm used to articulate the chair during raising and lowering. In some embodiments, one may reason that an alternative example of a lift receiver assembly 70 may be, an assembly where the leveling rod is not housed within. In the preferred embodiment, the lift receiver assembly 70 preferably comprises a receiver arm connection bracket 71, and the vertical adjustment bracket 72, respectively.

The receiver arm connection bracket 71 is preferably positioned as part of the lift receiver assembly 73. The receiver arm connection bracket 71 is designed to both 1) bind the vertical adjustment bracket and to 2) house the belt connection assembly. Further, the receiver arm connection bracket 71 preferably comprises an additional sub-component herein termed the belt connection assembly 74.

The belt connection assembly 74 FIG. 10 is preferably positioned within the receiver arm connection bracket 71. The belt connection assembly 74 is designed to both 1) bind the end of the belt so that when the motor is activated the lifting arm will raise and to 2) have a pivot point so that when the lifting arm is being raised, that the belt will adjust its position. The vertical adjustment bracket 72 is preferably positioned within the lift receiver assembly 70. One goal of the vertical adjustment bracket 72, is to connect the receiving collar for the chair, while providing a pivot point via the leveling rod for controlling the pitch of the chair when it is being raised. The vertical adjustment bracket 72 has sub-components: including the receiving collar attachment region 76, the leveling rod region 77, and the lifting arm region 78.

In the preferred embodiment, the receiving collar attachment region FIG. 11 76 is preferably positioned next to the leveling rod region 77 and next to the lifting arm region 78. One goal of the receiving collar attachment region 76 is to bind to the receiving collar. Further, the receiving collar attachment region 76 preferably comprises an additional sub-component herein termed the receiving collar 79.

The receiving collar 79 is preferably positioned at the end of the receiving collar attachment region 76. The receiving collar 79 is designed to both 1) have a means to bind to the lifting arm for vertical lift and attachment and to 2) form a shape that conforms to the stem of the chair for lifting. In some embodiments, one may reason that an example of a receiving collar 79 may be a means to bind to the lifting arm for vertical lift but a horizontal attachment. Further, the receiving collar 79 preferably comprises an additional sub-component herein termed the collar stem aperture 80.

The collar stem aperture 80 is preferably positioned within the receiving collar 79. The collar stem aperture 80 is designed to both 1) hook on the chair stem and to 2) form the main point of contact between the lift and the chair. In the preferred embodiment, the leveling rod region 77 is preferably positioned next to the lifting arm region 78 and adjacent to the receiving collar attachment region 76. One goal of the leveling rod region 77 is to bind to the leveling rod. In the preferred embodiment, the lifting arm region 78 is preferably positioned next to the leveling rod region 77 and adjacent to the receiving collar attachment region 76. One goal of the lifting arm region 78 is to bind to the lifting arm.

The elbow end region 67 FIG. 12 is preferably positioned at the proximal end of the lifting arm 53. The elbow end region 67 preferably comprises a leveling rod pin aperture 81, the lifting arm spacers 82, and the lifting arm pivot pin 83.

The leveling rod pin aperture 81 is preferably positioned within the elbow end region. One goal of the leveling rod pin aperture 81 is to allow the spacing for the leveling road to articulate while inside the lifting arm. The lifting arm spacers 82 are preferably positioned between the interior surface of the elbow end and leveling rod. One goal of the lifting arm spacers 82 is to provide spacing when inserting on the vertical adjustment bracket 72 to prevent rolling or shifting. The lifting arm pivot pin 83 is preferably positioned adjacent to the lifting arm spacers 82. One goal of the lifting arm pivot pin 83 is to allow the lifting arm 53 to rotate when connected to the elbow.

The articulating mechanism 68 FIG. 12 and FIG. 9 is preferably positioned within the lifting arm 53. In some embodiments, it is reasonable to contemplate that an example of an articulating mechanism 68 may also be 1) a gyroscope detecting level means which would level the chair based on meter feedback, 2) a balanced attachment point present on the chair, that could be manually articulated, 3) a leveling rope operated by the user, or 4) a flexible cable that interacts with the lifting arm in order to articulate the chair. Further, the articulating mechanism 68 preferably comprises a self leveling rod 84.

The self leveling rod 84 is preferably positioned within the lifting arm 53. The self leveling rod 84 is designed to both 1) have a means by which the chair can remain level when lifting and to 2) insert through the lifting arm. In the preferred embodiment, the self leveling rod 84 includes two sub-items, the elbow rod attachment region 85, and the receiver attachment region 86, respectively. In alternative embodiments, the self leveling rod may be replaced by chain, cables, ropes or wires.

The elbow rod attachment region FIG. 12 is preferably positioned at the proximal end of the self leveling rod 84. Further, the elbow rod attachment region 85 preferably comprises an additional sub-component herein termed the elbow rod pivot pin 87.

The elbow rod pivot pin 87 is preferably positioned within the elbow rod attachment region 85. One goal of the elbow rod pivot pin 87 is to have a means by which the elbow rod can pivot when articulating during a lift. The receiver attachment region 86 is preferably positioned at the distal end of the self leveling rod 84. Further, the receiver attachment region 86 preferably comprises an additional sub-component herein termed the receiver rod pin 88.

The receiver rod pin 88 FIG. 11 is preferably positioned within the receiver attachment region 86. One goal of the receiver rod pin 88 is to insert on the vertical adjustment bracket 72 and allow articulation during lifting. Further, the receiver rod pin 88 preferably comprises an additional sub-component spacers 89, positioned adjacent to the receiver rod pin 88. One goal of the spacers 89 is to provide spacing when inserting on the vertical adjustment bracket 72 to prevent rolling or shifting.

In the preferred embodiment, the detachable lower support arm 54 FIG. 13 is preferably positioned above the base and below the lifting arm. One goal of the detachable lower support arm 54 is to have a detachable means to connect the arm assembly to the base. It is also not necessary that the detachable lower support arm 54 be used. In some embodiments, one may reason that if the detachable lower support arm 54 is absent, than the arm may be permanently affixed. In other instances, if detachable lower support arm 54 is absent than may be a straight shaft. In the preferred embodiment, the detachable lower support arm 54 preferably comprises a no load support region 90, and the lower support end region 91, respectively.

The no load support region 90 is preferably positioned the bottom end of the detachable lower support arm 54. In the preferred embodiment, the no load support region 90 preferably includes the locking mechanism 92, and the no load end 93, respectively.

The locking mechanism 92 FIG. 14 is preferably positioned at the lower end of the lower support arm. The locking mechanism 92 is designed to both 1) have a means to attach the support arm to the base and to 2) have a means to slide the support arm so that it can be detached when the locking pin 150 is removed. The locking mechanism 92 preferably comprises a top region 94, the locking pin aperture 95, the locking pin sliding groove 96, and the locking mechanism lower support arm attachment region 97. The top region 94 is preferably positioned at the top of the locking mechanism 92. One goal of the top region 94 is to provide a load bearing mechanism to work in concert with the top mounting pin. The locking pin aperture 95 is preferably positioned in the center of the locking mechanism 92. One goal of the locking pin aperture 95 is to have a hole within which the locking pin 150 can be inserted, so that the lower support arm is permanently bound to the lower arm mount.

The locking pin sliding groove 96 is preferably positioned between the lower support arm 43 and locking mechanism lower support arm attachment region 97. One goal of the locking pin sliding groove 96 is to have the locking pin slide into the locking mechanism, in order to form the structural support. The locking mechanism lower support arm attachment region 97 is preferably positioned between the top region 94 and the lower support arm 43. One goal of the locking mechanism lower support arm attachment region 97 is to bind the locking mechanism to the lower support arm.

The no load end 93 FIG. 15 is preferably positioned at the ground surface of the no load support region 90. One goal of the no load end 93 is to have a specific shape or configuration on the end of the lower support arm that allows it to stand and remain clear of the floor. In the preferred embodiment, the no load end 93 includes two sub-items, the floor clearance angle edge 98, and the support buttress angle, respectively. In the preferred embodiment, the floor clearance angle edge 98 is preferably positioned facing the bottom surface (floor) and on the no load end 93. One goal of the floor clearance angle edge 98 is to have an edge be parallel to the floor so that when the support arm is open that the arm does not touch the ground. The support buttress angle 99 is preferably positioned facing the unfolding mechanism on the no load end 93. One goal of the support buttress angle 99 is to have an edge that buttresses to the middle no load mounting surface 37 which allows it to stand when there is no load on the device. The lower support end region 91 FIG. 16 is preferably positioned at the top end of the detachable lower support arm 54. One goal of the lower support end region 91 is to bind to the assembly elbow.

In the preferred embodiment, the assembly elbow 55 FIG. 1 and FIG. 2 is preferably positioned at the junction of the arms and surrounding the proximal arms of the invention. It is also not necessary that the assembly elbow 55 be used. In some embodiments, one may reason that if the assembly elbow 55 is absent, than the lower support arm may mimic the functionality of the assembly elbow and provide the necessary structural components to bind the components of the arm assembly. In other instances, if assembly elbow 55 is absent than, multiple pieces may be configured to provide the functionality of the elbow assembly. The assembly elbow 55 preferably includes an elbow upper arm region 100, the elbow lifting arm region 101, and the elbow support arm region 102.

The elbow upper arm region 100 is preferably positioned at the top of the assembly elbow 55. FIG. 2 One goal of the elbow upper arm region 100 is to connect and mediate the arm assembly to the upper support arm. In the preferred embodiment, the elbow upper arm region 100 includes two sub-items, the upper arm support sleeve 103, and the upper arm load bearing bolt 104, respectively.

The upper arm support sleeve 103 is preferably positioned within the assembly elbow. One goal of the upper arm support sleeve 103 is to provide a locking unlocking means for the top support arm, so that it can be locked when lifting and unlocked and pivoted when being folded. The upper arm support sleeve 103 preferably comprises an upper arm support sleeve pivot slot 105, the support sleeve elbow surface 106, the support sleeve top aperture 107, the support sleeve back aperture 108, the support sleeve front aperture 109, the support sleeve front plate 110, the support sleeve bottom aperture 111, and the support sleeve pin 112.

The upper arm support sleeve pivot slot 105 is preferably positioned within the assembly elbow. FIG. 17 and FIG. 18 The upper arm support sleeve pivot slot 105 is designed to both 1) allow the pin connected to the upper support arm to slide our for folding/unfolding and to 2) allow the pin connected to the upper support arm to slide in for engagement to a load bearing position. In the preferred embodiment, the support sleeve elbow surface 106 is preferably positioned within the assembly elbow and adjacent to the assembly elbow 55. One goal of the support sleeve elbow surface 106 is to bind to the assembly elbow. In the preferred embodiment, the support sleeve top aperture 107 is preferably positioned within the assembly elbow and at the top of the upper arm support sleeve 103. The support sleeve top aperture 107 is designed to both 1) removably insert the top support arm and to 2) allow the top support arm to swivel.

The support sleeve back aperture 108 is preferably positioned at the back of the upper arm support sleeve 103. FIG. 17 The support sleeve back aperture 108 is designed to both 1) removably insert the top support arm and to 2) allow the top support arm to swivel. The support sleeve front aperture 109 is preferably positioned at the front of the upper arm support sleeve 103. The support sleeve front aperture 109 is designed to both 1) removably insert the top support arm and to 2) allow the top support arm to swivel. One goal of the support sleeve front plate 110 is to provide support for when the top arm is in the locked position.

The support sleeve bottom aperture 111 is preferably positioned at the bottom of the upper arm support sleeve 103. One goal of the support sleeve bottom aperture 111 is to allow the lifting arm clearance when folding. The support sleeve pin 112 is preferably positioned within the upper arm support sleeve 103. The support sleeve pin 112 is designed to both 1) hold the sleeve in place and to 2) support the upper arm when in the locked position.

The upper arm load bearing bolt 104 is preferably positioned within the elbow upper arm region 100. The upper arm load bearing bolt 104 is designed to both 1) bear the load of the upper arm, when in the locked position and to 2) inform the correct position when the arm will be locked.

In the preferred embodiment, the elbow lifting arm region 101 FIG. 19 includes two sub-items, the rod pin insertion aperture 113, and the lifting arm pivot pin aperture 114, respectively. The rod pin insertion aperture 113 is preferably positioned through the assembly elbow 55 and in the middle of the assembly elbow 55. One goal of the rod pin insertion aperture 113 is to bind the leveling rod to the elbow assembly. In the preferred embodiment, the lifting arm pivot pin aperture 114 is preferably positioned through the assembly elbow 55 and in the middle of the assembly elbow 55. One goal of the lifting arm pivot pin aperture 114 is to bind the lifting arm to the elbow assembly.

The elbow support arm region 102 FIG. 19 is preferably positioned at the bottom of the assembly elbow 55. In the preferred embodiment, the elbow support arm region 102 includes two sub-items, the elbow attachment forward bolt 115, and the elbow attachment back bolt 116, respectively. In the preferred embodiment, the elbow attachment forward bolt 115 is preferably positioned through the assembly elbow 55 and in the middle of the assembly elbow 55. One goal of the elbow attachment forward bolt 115 is to bind the lower support arm to the elbow assembly. In the preferred embodiment, the elbow attachment back bolt 116 is preferably positioned through the assembly elbow 55 and in the middle of the assembly elbow 55. One goal of the elbow attachment back bolt 116 is to bind the lower support arm to the elbow assembly.

In an alternative embodiment of the invention, the arm assembly may instead be replaced by a straight shaft. The shaft provides a straight stable lifting surface for lifting the chair and would further comprise the roller assembly 117 to have a sliding stable connection to the liftable object. The roller assembly 117 preferably comprises a roller body 118, roller wheels 119, roller chair attachment means 120, and a power connection means 121.

In this embodiment, the roller body 118 is designed to both 1) surround the shaft and add stability while lifting and to 2) bind to the chair. The roller wheels 119 are designed to both 1) decrease friction between the shaft and the roller body and to 2) allow for lifting and lowering of the roller assembly. One goal of the roller chair attachment means 120 is to attach to the chair and operably attach to the roller body. The aforementioned power connection means 121 is a connection to a motor or power so that the roller body can be lowered or raised. When using the invention, it is thought that an example of power connection means 121 might be a belt attachment, or also perhaps also a screw drive insertion plate.

In some embodiments, there is a chair motor assembly that removably detaches from the collar of the lifting arm (attached in FIG. 20) and is the means by which an object such as a wheelchair or scooter can be lifted. It preferably includes a connection bracket, a disconnection unit 122, and a motor assembly 123.

One goal of the connection bracket is to structurally connect the motor assembly to the chair. In some embodiments, one may reason that an example of a connection bracket may be just a simple bracket. Further, the connection bracket preferably comprises the connection bracket pivot 124.

The connection bracket pivot 124 FIG. 20 is designed to both 1) provide means for pitch, roll, and yaw flexibility and to 2) allow someone to adjust the chair for angling into tight spaces. In some embodiments, it is reasonable to contemplate that an example of a connection bracket pivot 124 may also be u-bolts, a collared bracket, or a ball joint. It is also not necessary that the connection bracket pivot 124 be used. In some embodiments, one may reason that if the connection bracket pivot 124 is absent, then the connection bracket may be rigid. In other instances, if the connection bracket pivot 124 is absent than the assembly arm may be used to provide flexibility in positioning the chair.

In an alternative embodiment there is a disconnection unit. The disconnection unit 122 is designed to both 1) enable relocation of motor to other operable places and to 2) quick release of the chair motor assembly to move to a different chair. In some embodiments, it is reasonable to contemplate that an example of a disconnection unit 122 may also be 1) a cotter pin within nested structures, 2) a nested piping means, or 3) a quick connect valve or socket. In some embodiments, one may reason that if the disconnection unit 122 is absent, than the motor may remain attached to the chair.

In some embodiments there is a motor assembly 123 which preferably comprises housing 125 which inside has a drive assembly 126, a belt holder 127, a belt aperture 59, a positioning roller, and a stem 128. The drive assembly 126 in turn preferably comprises a reduction unit 129, a shaft 130, a sprocket 131, and a chain 132. In some embodiments, one may reason that an example of a chain 132 may be instead replaced with helical gears. One goal of the belt holder 127 is to translate motor movement into winding or unwinding of the belt. In the preferred embodiment, the belt holder 127 preferably comprises a belt sprocket 133, and a belt spool 134, respectively. These translate the movement of the motor into rotation of the belt roller. Instead of a belt sprocket 133 alternative means could be helical gears, direct gears, or worm gears. One goal of the belt aperture 59 is to have an opening in the housing that the belt can pass through. One goal of the positioning roller is to protect the belt from being destroyed by the housing.

The belt 4 is generally contemplated to be created from nylon but in some embodiments is reasonable to imagine that that the belt 4 could also be created from carbon reinforced thread or synthetic or natural material. When using the invention, it is thought that an example of a belt 4 might be a chain or also a rope.

One goal of the stem 128 is to have a support means to operably connect to the receiver collar 135 on the lifting arm. When using the invention, it is thought that an example of a stem 128 might be an insertion stem, which is operated via horizontal attachment rather than vertical attachment or perhaps also a quick connection (ball; similar to a power washer).

It will be appreciated by those skilled in the art that changes could be made to the embodiments described herein without departing from the broad inventive concept thereof. It is understood, therefore, that this invention is not limited to the particular embodiments disclosed, but it is intended to cover modifications within the spirit and scope of the present invention as defined by the appended claims.

I claim:

1. An apparatus comprising;
a base, a lifting assembly, and a motor assembly.

2. The apparatus of claim 1 wherein said base comprises two or more base support pieces.

3. The apparatus of claim 2 wherein said base support pieces each comprise a lateral arm and a forward arm.

4. The apparatus of claim 3 wherein said forward arm comprises a latch that operably interacts with a component of the lifting assembly.

5. The apparatus of claim 4 wherein said forward arm comprises one or more casters.

6. The apparatus of claim 1 wherein said lifting assembly comprises an upper support arm, a lifting arm and a lower support arm.

7. The apparatus of claim 6 wherein said upper support arm comprises a belt roller.

8. The apparatus of claim 7 wherein said belt roller comprises one or more handles.

9. The apparatus of claim 6 wherein said lifting arm comprises a means for articulation.

10. The apparatus of claim 9 wherein said lifting arm comprises a receiving collar.
